(19) United States
(12) Patent Application Publication
(10) Pub. No.: US 2004/0091847 A1
(43) Pub. Date: May 13, 2004

(54) Paper-based adaptive testing

(75) Inventor: Roger Packard Creamer, Pacific Grove, CA (US)

Correspondence Address: ROTHWELL, FIGG, ERNST & MANBECK, P.C., 1425 K STREET, N.W., SUITE 800, WASHINGTON, DC, 20005, US

(73) Assignee: CTB/McGraw-Hill, Monterey, CA

(21) Appl. No.: 10/701,690

(22) Filed: Nov. 6, 2003

Related U.S. Application Data
(60) Provisional application No. 60/424,006, filed on Nov. 6, 2002.

(51) Int. Cl. G09B 3/00; G09B 7/00

(52) U.S. Cl. 434/353

(57) ABSTRACT

A system and method for administering adaptive tests employs computer technology for item storage, response storage and scoring, and item selection, but permits examinees to write item responses on paper response sheets. The handwritten responses are electronically captured so as to create electronic data corresponding to the response. The electronic data can thereafter be electronically processed, e.g., stored, sorted, transmitted, displayed, scored, etc.

### CLAIMS FOR PRIORITY

This application claims the benefit under 35 U.S.C. § 119(e) of the filing date of provisional patent application Serial No. 60/424,006 filed Nov. 6, 2002, which is incorporated herein by reference.

### BACKGROUND OF THE INVENTION

1. Field of the Invention

The present invention relates, generally, to a system for and methodology of administering adaptive tests in which the examinee responds to test items by writing or marking answers on paper.

2. Description of the Background Art

In fixed item tests administered in a paper-and-pencil format, every examinee sees the same items within a given test. Since every examinee is presented with the same set of test items, most examinees typically are administered at least some items that are either very easy or very difficult for them. Items that are either very easy or very difficult for the examinee to provide little information about the examinee's ability level, and reduce the precision of measurement values based on the assessment administration.

Computer adaptive tests (CAT) have been developed to iteratively estimate the examinee's ability level. With CAT, the computer, controlled by suitable software applications, updates the estimate of the examinee's ability level after each item or set of items, based on the examinee's performance on the item or set of items. The updated ability estimate can then be used in the selection of subsequent items or sets of items to be administered to the examinee. The items are selected for administration to each examinee so as to maximize the information that can be derived about their ability level. Accordingly, each examinee is given very few items that are either very easy or very hard for that examinee. Therefore, properly tailored adaptive testing schemes administered by CAT can result in a reduction in the number of items that must be administered to an examinee to estimate the examinee's ability level. Accordingly, CAT can be significantly more efficient than fixed item paper-and-pencil or online tests.

Test items to be presented to an examinee in conventional implementations of CAT occur on a computer screen or monitor, and responses are made by the examinee via a computer input device (e.g., a keyboard, mouse, touch sensitive screens, etc.). The response items are then scored (preferably promptly, i.e., within minutes of their being submitted for scoring), and an item selection algorithm selects the next item or set of items to be presented to the examinee.

One shortcoming of CAT, however, is that because each examinee must use a computer input device to respond to each item, administration of CAT can be expensive and technologically complex. In addition, not all examinees have the same level of proficiency in using such computer input devices, and thus assessment results can be affected by these variations in proficiency. Examinees with low levels of proficiency can be disadvantaged relative to those with higher proficiencies.

Accordingly, there remains a need for a system and methodology for overcoming the shortcomings of traditional CAT administration which can provide the benefits of adaptive testing in a manner that is less expensive and technologically simpler than conventional CAT administration, and which does not result in performance variations due to variations in examinee's proficiencies in the use of computer input devices.

### SUMMARY OF THE INVENTION

One aspect of the invention is embodied in a method of administering an adaptive assessment on paper media. The method includes (a) selecting one or more assessment items, (b) printing the selected assessment items on paper media to create an assessment document, (c) storing item identity and item response position information for each item, (d) providing a unique identification for each assessment document, each unique identification being associated with one examinee, (e) allowing each examinee to prepare a response to each item contained in that examinee's assessment document, each response being a response written or marked on the paper media, (f) creating an electronic record of every response prepared by each examinee, (g) for each examinee, scoring each response using the stored item identity and item response position information for each item, and associating an item score with the examinee using the unique identification associated with that examinee, (h) automatically selecting additional assessment items, if any, that will be administered to each examinee based on the examinee's score to the previously administered test items, and (i) repeating steps (b) through (h) for assessment items remaining to be administered to yield the desired assessment measurements at a desired level of measurement precision.

Another aspect of the invention is embodied in a method for presenting an adaptive assessment to an examinee. The method comprises selecting one or more items for presenting to the examinee and providing an item response sheet to the examinee on which a response to each of the items can be handwritten or marked by the examinee using a writing instrument. An electronic data record of the handwritten response is created and the data record is evaluated to assign a score for the response. One or more additional items to be presented to the examinee are selected or the assessment is terminated based at least in part on the score assigned to the response.

Another aspect of the invention is embodied in a system for presenting an adaptive assessment to an examinee. The system comprises item selection means for selecting one or more items for presenting to the examinee, means for creating an electronic data record of the examinee's handwritten response to an item, means for evaluating the electronic data record to assign a score for the response, and means for either selecting one or more additional items to be presented to the examinee or terminating the assessment based at least in part on the score assigned to the response.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same become better understood by reference to the following detailed description when considered in connection with the accompanying drawings, wherein:

FIG. 1 is a flow chart illustrating a methodology of administering an adaptive assessment according to the present invention.

FIG. 2 schematically illustrates a system for administering an adaptive assessment according to the present invention.

### DETAILED DESCRIPTION OF THE EXEMPLARY EMBODIMENTS

In the following description, for purposes of explanation and not limitation, specific details are set forth, such as communication networks, computers, terminals, devices, components, techniques, software products and systems, operating systems, hardware, etc. in order to provide a thorough understanding of the present invention. However, it will be apparent to one skilled in the art that the present invention may be practiced in other embodiments that depart from these specific details. Detailed descriptions of well-known communication networks, computers, terminals, devices, components, techniques, software products and systems, operating systems, and hardware are omitted so as not to obscure the description of the present invention.

The present invention provides a system for and methodology of capturing and processing handwritten responses by integrating methods of electronically (e.g., digitally) capturing handwriting into the administration of adaptive assessments. In the context of the present disclosure, the terms “handwriting” or “handwritten response” refer to any letter, symbol, number, graphic element, mark, etc. written or drawn by hand on a writing surface using a writing instrument.

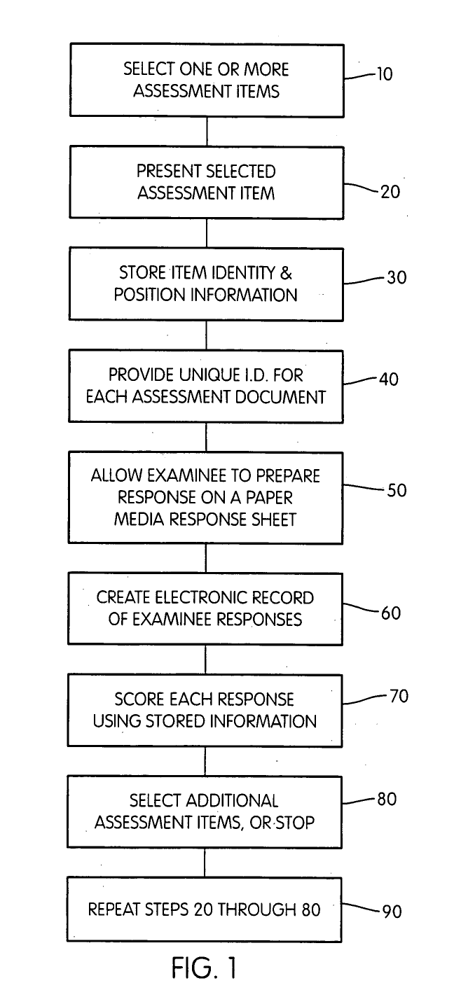

FIG. 1 is a flow chart illustrating a method of administering an adaptive educational assessment on paper media or in an electronic format according to the present invention. The method makes significant use of computer resources. For example, items to be presented to an examinee are preferably stored electronically in an item storage database, or item bank. Computer applications are employed to select items for presentation, to analyze examinee responses to items presented, and to select subsequent items for presentation based on examinee performance on prior-presented items, or alternatively, to determine if a stop criteria has been satisfied, in which case no further items are presented to the examinee. The item itself, i.e., the stimulus, the stem, directions, and possible responses (for a selected response item), may be presented to the examinee on a computer. The actual response is created by the examinee on a paper response sheet using a pen or pencil. Thus, the examinee need not be proficient in the use of computer input devices, and computer input devices need not necessarily be available for all examinees.

According to the method of administering an adaptive assessment on paper media or in an electronic format illustrated in FIG. 1, one or more educational or informational domains to be assessed are selected by a test administrator. For each selected domain, an initial item or set of items is selected in step 10, and the selected item(s) for all selected domains are presented to the examinee on paper media or in an electronic format in step 20. Alternatively, items may be presented verbally. In one embodiment of the invention, items eligible to be selected for presentation to the examinee are stored in an item bank. The identities of all items presented to the examinee are stored in a database (step 30). The examinee will respond to each item on a response sheet, preferably made from paper and preferably preprinted with an area designated on the sheet for locating the examinee's response. The response positions for all items are also stored in a database (step 30). In addition, the identity (if known) of the examinee receiving the assessment or a unique identification of each assessment document will also be stored in step 40.

In step 50, the examinee responds to the assessment item or items on the assessment document response sheet by marking the sheet with a writing instrument (e.g., a pen or pencil). The response may comprise a constructed response consisting of words, numbers, symbols, etc., created by the examinee on the response sheet, or the response may comprise a selected response in which the examinee makes a mark on the response sheet indicating the examinee's selection of one of two or more alternate responses provided to the examinee.

The responses, examinee information, and document identifying information are captured either in real time by a recording device or after assessment administration using a digital scanner (step 60). A recording device and a scanner comprise examples of a handwriting conversion device which is constructed and arranged to electronically capture handwriting by converting handwriting to an electronic data record. An example of a suitable recording device includes a digitally recording writing instrument, such as those described in co-pending, commonly-assigned application serial no. __/___,__ (attorney docket 2736-121) entitled “System and Method of Capturing and Processing Handwritten Responses on the Administration of Assessments,” the disclosure of which is hereby incorporated by reference.

One particular digitally recording writing instrument that is suitable is a device developed by Anoto AB of Sweden. A version of the digitally recording writing instrument developed by Anoto AB is commercially available from Logitech® under the name of Personal Digital Pen.

In the Anoto system, an optically-readable position coding pattern, which is not apparent to the human eye, is formed on the writing surface using standard offset printing techniques and ordinary carbon-based ink or any other infra-red absorbing ink. The position coding pattern uniquely identifies positional coordinates on the writing surface. A writing instrument (e.g., a hand-held pen) has attached thereto or integrally assembled therewith a sensing device for electronic recording of what is being written or drawn with the writing instrument. The sensing device includes optics, electronic circuitry, and power supply components. Using the optics components, the circuitry reads images, e.g., generally at a frequency of 60 to 100 images per second, determines the position coding pattern in each image, and determines the positional coordinates corresponding to the pattern. Accordingly, the sensing device can determine where the writing instrument is on the writing surface and what is being written.

Selected or restricted responses can be captured using a digitally recording writing instrument or the like. An examinee can mark a designated response area to indicate their answer choice in a manner analogous to marking “bubbles” on an Optical Mark Read (OMR) bubble sheet. The examinee marks the answer choice by placing strokes into or around a designated answer choice response area. Preferably, some means is provided to allow the examinee to change an answer. For example, if the examinee wishes to change a previously selected answer, the examinee can cross out an answer (e.g., draw an “X” across the selected answer), and then select another answer. To re-select a previously crossed out answer, the examinee merely circles the crossed out answer.

Alternatively, OMR bubble sheets can be used as response sheets, and the examinee can mark the responses directly on the sheet, preferably using a #2 pencil.

Accordingly, examinees can be given adaptive test items and can respond to those items in the more familiar and less expensive paper and pencil format. The captured information is electronically transferred to a processing computer system. If there is more than one examinee, one or more computer systems may be used to process the assessment results. In the exemplary embodiment, only one computer system is used to process the results from multiple examinees.

As illustrated in step 70 of FIG. 1, all response items are scored after being electronically recorded. Scoring is preferably performed on the digital data records of the responses prepared by the examinee. Because the response position is stored, the examinee's response is readily located for purposes of capturing the response and later scoring the electronically captured response. Using an item selection algorithm, one or more additional items for each domain for each examinee is selected (step 80), unless the algorithm determines that no further testing for a domain is required (i.e., a stop criteria has been satisfied). A variety of item selection algorithms are known to those skilled in the art and will not be described in any detail herein. Suitable selection algorithms include, but are not limited to, Maximum Information, Owen's Approximate Bayes Procedure, Maximum Global-Information, Likelihood-Weighted Information, Weighted-Deviation Method, Shadow Tests, and Multi-Stage Tests. If the examinee requires further testing, the selected items for all remaining domains are presented to the examinee. The additional selected items may be printed and presented on paper media, the additional items may be presented to the examinee in electronic format, or the additional items may be presented verbally.

Response data is processed (e.g., scored) electronically and subsequent items for further testing, if required, are generated by the item selection algorithm and the responses to those subsequent items, after being electronically captured, will also be processed electronically. Therefore, it is important that response sheets and assessment documents, if assessment items are presented on paper media, be uniquely identified to ensure that assessment items are administered to the correct examinee, and the corresponding response scores are associated with the correct examinee.

Several methods can be used to uniquely identify each examinee's document. For example, each document can be uniquely identified with a preprinted identification field that is detected by a response capturing device (e.g., a bar code), or each examinee can enter unique identifying information onto the document that is detectable by the response capturing device. The identity and response positions of all items on each document are stored in a document database, along with the identity, if known, of the examinee receiving the document.

In step 90, steps 20 through 80 are repeated for assessment items remaining to be administered. Administrative and scoring reports can be produced to reflect the current status of the assessment process.

The paper adaptive test of the present invention involves selection and administration of one or more items, capture of the examinee's response, scoring and evaluating the response, and selection and administration of additional items, if necessary. Thus, the test administration time can be longer for the paper adaptive test than for the computerized adaptive test which is more fully automated and interactive than the paper adaptive test. Efficiency of the paper adaptive test may be improved by simultaneously testing more than one educational domain (e.g., math, science, and reading). The domains are processed individually in terms of criteria used for subsequent item selection and stop criteria, and in fact, an examinee may reach stop criteria for the different domains at different times. In a sense, the tests for the different domains comprise separate, independent tests that are administered concurrently. Efficiency can be improved because the paper adaptive test administration process need not be performed in its entirety for each separate educational domain.

This process of testing multiple educational domains concurrently differs from typical administration of CAT, in which, because of the speed and interactivity provided by a fully computerized test administration, each domain is tested to a stopping point before moving on to the next domain.

The method of administering an adaptive assessment on paper media or in electronic format can be implemented by a system including a computerized item database containing sufficient items for the item selection algorithm to provide valid test results for the educational or informational domain to be assessed. The database can contain information about how to format each item for printing, sufficient statistical and/or content-related information for the item selection algorithm to work, etc. A printer, a computer and associated software application(s), a computer database or data file for keeping track of the items and response item positions on each document, a computer database or data file for keeping track of each examinee's test results, and a paper scanning device or a recording device for capturing responses are also provided.

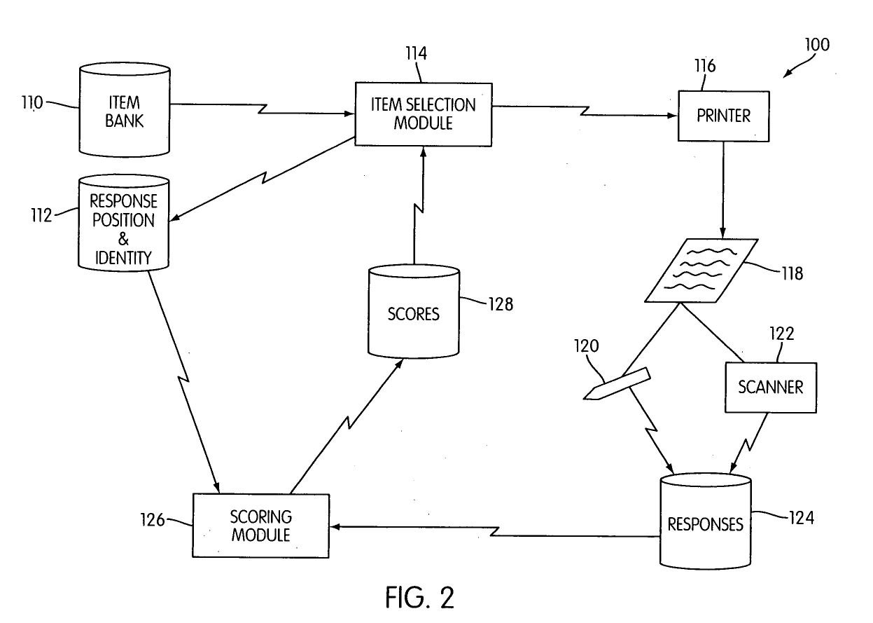

More specifically, FIG. 2 schematically illustrates an adaptive assessment system 100 according to an embodiment of the present invention. The system 100 includes an item selection module 114, which, in the preferred embodiment, is that portion of a computer software program which implements an item selection algorithm. The item selection module 114 selects one or more items stored in an item bank 110, which is that portion of a machine readable storage media on which previously prepared items are stored and cataloged. The item(s) selected from the item bank 110 by the item selection module 114 are chosen based on predefined criteria which depend on whether the items being chosen are the initial items to be administered to the examinee or are subsequent assessment items to be administered after the examinee has completed prior-administered items. These criteria are known to those skilled in the art and will not be described in detail herein.

After selecting the item(s) from the item bank 110, the item identity and response position are stored in the response position and identity database 112, preferably comprising a machine readable/machine writable storage medium. The selected items—assuming administration on paper media—and item response sheets 118 are printed by the printer 116, which is in communication with the item selection module 114. If the reponses to the items are to be made using a digital recording writing instrument, such as the device developed Anoto AB described above, response sheets 118 are printed on paper having the optically readable position coding pattern. The examinee then marks each response on the item response sheet 118, and the responses are stored as a digital data record in the response database 124 via a handwriting capture device, such as a digitally recording writing instrument 120, which creates a digital data record of the response marks as they are created by the examinee, or a digital scanner 122 which scans the responses from the item response sheet 118. Response database 124 is preferably a machine readable/machine writable storage medium.

A scoring module 126 is, in the preferred embodiment, that portion of a computer software program which implements algorithms for automated scoring of examinee responses or for facilitating semiautomated scoring of examinee responses in which a human reads and evaluates electronically stored and displayed responses (See e.g., U.S. Pat. No. 5,672,060, the disclosure of which is hereby incorporated by reference). Scoring module 126 reads the digital data records of the responses stored in response database 124 and the item identity and response position data stored in database 112 and generates, with or without human assistance, response scores that are stored in score database 128. Score database 128 is preferably a machine readable/machine writable storage medium.

Thereafter, the item selection module 114 reads the scores in the score database 128 and, applying a stop criteria per educational or informational domain being assessed and a predefined item selection criteria, either selects additional items per domain from the item bank 110 based on the scores read from the score database 128 or terminates testing a domain if its stop criteria has been met. Testing stops when all domains being assessed reach a stop condition.

It should be noted that the databases 110, 112, 124, and 128 need not be distinct storage media, but may be different portions (i.e., files) within a particular storage medium.

Where the adaptive testing is administered via paper media, the present invention still provides the benefits of interactive computer adaptive testing. By using paper media for item presentation and response capturing, test administration expenses and technical problems experienced during a testing session can be significantly reduced. Moreover, all examinees can prepare responses in a format with which they are familiar. Since multiple educational or informational domains may be assessed concurrently, considerable flexibility and administrative optimization can be achieved by adjusting the number of domains or items to be administered at one time. For example, it might be desired to include sufficient items in each iterative assessment cycle to optimally use a preset amount of scheduled assessment administration testing time, or to more fully utilize the space available on a scannable response sheet. To achieve such optimizations it would be possible to vary the number of domains being assessed for any given assessment iteration, as long as each domain being assessed ultimately reaches its stopping point.

The foregoing has described the principles, embodiments, and modes of operation of the present invention. However, the invention should not be construed as being limited to the particular embodiments described above, as they should be regarded as being illustrative and not restrictive. It should be appreciated that variations may be made in those embodiments by those skilled in the art without departing from the scope of the present invention.

What is claimed is:

1. A method of administering an adaptive assessment on paper media, said method comprising:
(a) selecting one or more assessment items;
(b) printing the selected assessment items on paper media to create an assessment document;
(c) storing item identity and item response position for each item;
(d) providing a unique identification for each assessment document, each unique identification being associated with one examinee;
(e) allowing each examinee to prepare a response to each item contained in that examinee's assessment document, each response being a response written on the paper media;
(f) creating an electronic record of every item response prepared by each examinee;
(g) for each examinee, scoring each response using the stored item identity and item response position information for each item, and associating a score with the examinee using the unique identification associated with that examinee;
(h) automatically selecting additional assessment items, if any, that will be administered to each examinee based on the examinee's score to the previously administered test items; and
(i) repeating steps (b) through (h) for assessment items remaining to be administered.

2. The method of claim 1, wherein the step of creating an electronic record of every response comprises optically scanning the responses written on the paper media by each examinee.

3. The method of claim 1, wherein the step of creating an electronic record of every response comprises providing a digitally recording writing instrument to each examinee for preparing a written response to each assessment item on the paper media.

4. The method of claim 1, wherein said selecting step comprises selecting one or more items for each of two or more assessment domains.

5. A method for presenting an adaptive assessment to an examinee, the method comprising:
selecting one or more items for presenting to the examinee;
presenting the selected items to the examinee;
providing an item response sheet to the examinee on which a response to the selected items can be handwritten by the examinee using a writing instrument;
creating an electronic data record of the handwritten response;
evaluating the electronic data record to assign a score for the response; and
selecting one or more additional items to be presented to the examinee based at least in part on the score assigned to the response.

6. The method of claim 5, wherein the electronic data record is created by electronically scanning the item response sheet after the examinee has written a response on the sheet.

7. The method of claim 5, wherein the electronic data record is created by providing the examinee with a digitally recording writing instrument and thereafter electronically recording the examinee's handwriting with the digitally recording writing instrument as the examinee writes the response.

8. The method of claim 5, further comprising repeating the presenting, providing, creating, evaluating, and selecting additional items steps until a stop criteria is met, at which point, no further items are selected for the examinee.

9. The method of claim 5, wherein said presenting step comprises at least one of:
(a) showing the examinee an electronic representation of an item;
(b) showing the examinee the item in printed form; and
(c) describing the item to the examinee verbally.

10. The method of claim 5, wherein said selecting step comprises selecting one or more items for each of two or more assessment domains.

11. A system for presenting an adaptive assessment to an examinee, the system comprising:
item selection means for selecting one or more items for presenting to the examinee;
means for creating an electronic data record of the examinee's handwritten response to an item;
means for evaluating the electronic data record to assign a score for the response; and
means for either selecting one or more additional items to be presented to the examinee or terminating the assessment based at least in part on the score assigned to the response.

12. The system of claim 11, further comprising data storage means for storing items from which said items selection means can select items for presenting to the examinee.

13. The system of claim 11, further comprising data storage means for storing said electronic data records.

14. The system of claim 11, further comprising data storage means for storing scores assigned to the responses.

15. A system for presenting an adaptive assessment to an examinee, the system comprising:
an item selection module constructed and arranged to select one or more items for presenting to the examinee;
a handwriting capture device constructed and arranged to convert the examinee's handwritten response to an item to an electronic data record; and
a scoring module constructed and arranged to evaluate the electronic data record to assign a score for the response corresponding to the electronic data record,
wherein said item selection module is further constructed and arranged to either select one or more additional items to be presented to the examinee or terminate the assessment based at least in part on the score assigned to the response.

16. The system of claim 15, wherein said handwriting capture device comprises a recording instrument constructed and arranged to electronically record an examinee's handwriting.

17. The system of claim 16, wherein said recording instrument comprises a digitally recording writing instrument with which an examinee may write out by hand an item response and which is constructed and arranged to electronically record the examinee's handwriting as the examinee writes out the item response.

18. The system of claim 15, wherein said handwriting capture device comprises a scanner for scanning an item response sheet on which the examinee has written one or more item responses.

19. The system of claim 15, further comprising a printer for printing selected items to be presented to an examinee.
